(19) United States
(12) Patent Application Publication
(10) Pub. No.: US 2025/0305165 A1
(43) Pub. Date: Oct. 2, 2025

(54) OXYGEN ELECTRODE FOR SOLID OXIDE ELECTROLYSIS CELL AND METHOD OF MANUFACTURING THE SAME

(71) Applicants: Hyundai Motor Company, Seoul (KR); Kia Corporation, Seoul (KR); Korea Institute of Science and Technology, Seoul (KR)

(72) Inventors: Ji Wan KIM, Yongin-si (KR); Si Won KIM, Uijeongbu-si (KR); Ji Hoon JANG, Yongin-si (KR); Shin Tae BAE, Incheon (KR); Hwi Tae KIM, Gwangmyeong-si (KR); Kyung Joong YOON, Seoul (KR); Sun Young PARK, Seoul (KR); Ji Eun WON, Seoul (KR); Mi Young PARK, Seoul (KR)

(73) Assignees: Hyundai Motor Company, Seoul (KR); Kia Corporation, Seoul (KR); Korea Institute of Science and Technology, Seoul (KR)

(21) Appl. No.: 18/816,536

(22) Filed: Aug. 27, 2024

(30) Foreign Application Priority Data
Apr. 1, 2024 (KR) 10-2024-0044089

(51) Int. Cl. C25B 11/077; C25B 11/031

(52) U.S. Cl. CPC C25B 11/0773; C25B 11/031

(57) ABSTRACT

The present disclosure relates to an oxygen electrode for solid oxide electrolysis cell and a method of manufacturing the same.

### CROSS-REFERENCE TO RELATED APPLICATION

The present application claims priority to Korean Patent Application No. 10-2024-0044089 filed on Apr. 1, 2024, the entire contents of which is incorporated herein for all purposes by this reference.

### BACKGROUND OF THE PRESENT DISCLOSURE

### Field of the Present Disclosure

The present disclosure relates to an oxygen electrode for solid oxide electrolysis cell and a method of manufacturing the same.

### Description of Related Art

Hydrogen is eco-friendly energy that may be produced using water. Demand for technology of producing hydrogen continuously grows, and its importance is increasing every year. There are various methods for producing hydrogen, such as water decomposition through electrolysis and a photocatalytic hydrogen production method. Among them, solid oxide electrolysis cell (SOEC) is a highly efficient water electrolysis technology.

The SOEC includes an electrolyte, a cathode, and an oxygen electrode. Water vapor decomposes at the cathode to produce hydrogen, and oxygen ions generated in this process pass through the electrolyte and move to the oxygen electrode. At the oxygen electrode, the oxygen ions become oxygen molecules.

The SOEC may be classified into an oxygen electrode-supported cell and an electrolyte-supported cell. The electrolyte-supported cell usually operates above 800° C., and the higher an operating temperature, the greater a current density. However, high operating temperatures cause an increase in the consumption of electrical energy, affect durability, and shorten the lifetime of the cell.

The cathode-supported cell operates at 650° C. to 700° C. of a lower temperature. It is important to develop a technology capable of producing hydrogen even at low temperatures to lower the energy required for driving and to study a method capable of producing hydrogen with high efficiency.

Meanwhile, oxygen ions generated during the process of producing hydrogen from the SOEC receive electrons from the air electrode and output as oxygen. During long-term operation of the SOEC, oxygen ions may accumulate at the interface between the electrolyte and the oxygen electrode, thereby causing interfacial peeling. Therefore, it is important to develop materials for the oxygen electrode to improve the interfacial stability and electrode efficiency between the electrolyte and the oxygen electrode.

The information disclosed in this Background of the present disclosure section is only for enhancement of understanding of the general background of the present disclosure and may not be taken as an acknowledgement or any form of suggestion that this information forms the related art already known to a person skilled in the art.

### BRIEF SUMMARY

Various aspects of the present disclosure are directed to providing an oxygen electrode for a solid oxide electrolysis cell capable of increasing cell performance.

The present disclosure is also directed to providing a solid oxide electrolysis cell having high interfacial stability between an oxygen electrode and an electrolyte.

The present disclosure is also directed to providing a solid oxide electrolysis cell having excellent durability.

The object of the present disclosure is not limited to the above-described. The objects of the present disclosure will become more apparent from the following description, and will be realized by means and combinations thereof described in the claims.

An oxygen electrode for a solid oxide electrolysis cell according to an exemplary embodiment of the present disclosure may include a support layer including internal pores, and a catalyst supported in the internal pores, wherein the catalyst may include a perovskite single phase structure.

The support layer may include at least one of compounds represented by Chemical Formulas 1, 2, 3, and 4 below:

A1ₙ₊₁B1ₙO₃ₙ₊₁ [Chemical Formula 1]

in Chemical Formula 1, A1 may include La, Nd, Pr, or Ga, and B1 may include Ni, Co, or Cu, and 1≤n≤3 can be satisfied,

A2₁₋ₓ₁A3ₓ₁B2_{1-y1}B3_{y1}O_{3-δ} [Chemical Formula 2]

in Chemical Formula 2, A2 may include La, Ba, or Y, A3 may include Sr or Ca, B2 and B3 may differ from each other and each include Mn, Co, Fe, or Ni, 0<x1<1, 0<y1<1 and 0≤8≤1 can be satisfied,

A4₁₋ₓ₂A5ₓ₂B4_{1-y2}B5_{y2}O_{3-δ}-C_{1-z}D_{z}O_{2-δ} [Chemical Formula 3]

in Chemical Formula 3, A4 may include La, Ba, or Y, A5 may include Sr or Ca, B4 and B5 may differ from each other and each include Mn, Co, Fe, or Ni, C may include Y, Sc, Gd, Sm, or Ca, D may include Zr or Ce, and 0<x2<1, 0<y2<1, 0<z<1, and 0≤8≤1 can be satisfied, and

A6₁₋ₓ₃3A7ₓ₃B6O_{3-δ} [Chemical Formula 4]

in Chemical Formula 4, A6 may include La, Ba, or Y, A7 may include Sr or Ca, B6 may include Mn, Co, Fe, or Ni, and 0<x3<1 and 0≤δ≤1 can be satisfied.

The hole transport auxiliary layer may contain the compound expressed by Formula 5:

A8ₓ₄A9₁₋ₓ₄B7O_{3-δ} [Chemical Formula 5]

In Chemical Formula 5, A8 and A9 may differ from each other and each include Sm, Sr, La, Ca, or Ba, B7 may include Co, Mn, or Fe, and 0<x4<1 and 0≤δ≤1 can be satisfied.

An average diameter of the catalyst may be in the range of 20 nm to 30 nm.

A method of manufacturing an oxygen electrode for a solid oxide electrolysis cell according to an exemplary embodiment of the present disclosure may include providing a reactant containing cations resulting from a catalyst precursor by dissolving the catalyst precursor, urea, and glycine in a solvent, obtaining an intermediate by injecting the reactant into a support layer containing internal pores, and thermally treating the intermediate to support the catalyst in the internal pores of the support layer.

The catalyst precursor may include at least one selected from the group consisting of nitrate of the cation, acetate of the cation, and combinations thereof.

The solvent may include the alcohol and water at a volume ratio of 0.1:1 to 2:1.

The cation may include at least one selected from the group consisting of Sm, Sr, La, Ca, Ba, Co, Mn, Fe, and combinations thereof.

The reactant may include urea and cations at a molar ratio of 5:1 to 15:1.

The reactant may include glycine and cations at a molar ratio of 0.5:1 to 5:1.

The support layer may be thermally treated at 300° C. to 400° C.

The manufacturing method may further include decomposing the urea by heating the intermediate to 70° C. to 100° C. before thermally treating the intermediate.

The supporting of the catalyst may include thermally treating the intermediate at 60° C. to 700° C.

According to an exemplary embodiment of the present disclosure, it is possible to obtain the oxygen electrode for a solid oxide electrolysis cell capable of increasing cell performance.

According to an exemplary embodiment of the present disclosure, it is possible to obtain the solid oxide electrolysis cell having high interfacial stability between the oxygen electrode and the electrolyte.

According to an exemplary embodiment of the present disclosure, it is possible to obtain the solid oxide electrolysis cell having excellent durability.

The effect of the present disclosure is not limited to the above-described effects. It should be understood that the effects of the present disclosure include all effects inferrable from the following description.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 shows a solid oxide electrolysis cell according to an exemplary embodiment of the present disclosure.

FIG. 2 shows the result of Fourier-transform infrared spectroscopy (FT-IR) analysis when urea and metal cation are bonded.

FIG. 3 shows the result of the FT-IR analysis when glycine and metal cations are bonded.

FIG. 4 shows the result of X-ray diffraction (XRD) analysis of the catalyst according to Manufacturing Example and Comparative Manufacturing Example 1.

FIG. 5 shows the result of the X-ray diffraction analysis of the catalyst according to Comparative Manufacturing Example 2.

FIG. 6 shows the result of the FT-IR of the catalyst according to Manufacturing Example and Comparative Manufacturing Example 1.

FIG. 7 shows the result of thermogravimetric analysis (TGA) of the catalyst according to Manufacturing Example and Comparative Manufacturing Example 1.

FIG. 8 shows the result of scanning electron microscope (SEM) analysis of an oxygen electrode for a solid oxide electrolysis cell according to Comparative Example 2.

FIG. 9 shows the result of the SEM analysis of the oxygen electrode for a solid oxide electrolysis cell according to Example 1.

FIG. 10 shows the result of sintering the oxygen electrode for a solid oxide electrolysis cell according to Example 1 at about 650° C. for about 100 hours and then analyzing the resultant using the SEM.

FIG. 11 shows the result of sintering the oxygen electrode for a solid oxide electrolysis cell according to Comparative Example 1 at about 650° C. for about 100 hours and then analyzing the resultant using the SEM.

FIG. 12 shows the result of observing the oxygen electrode for a solid oxide electrolysis cell according to Example 1 using the SEM.

FIG. 13 shows the result of observing the oxygen electrode for a solid oxide electrolysis cell according to Comparative Example 1 using the SEM.

FIG. 14 shows the result of measuring electrochemical performance of the solid oxide electrolysis cell according to Example 1.

FIG. 15 shows the result of measuring electrochemical performance of the solid oxide electrolysis cell according to Comparative Example 1.

FIG. 16 shows the result of measuring the polarization resistance of the solid oxide electrolysis cell according to Example 1 and Comparative Example 1.

FIG. 17 shows the result of measuring a degradation rate of the solid oxide electrolysis cell according to Example 2.

FIG. 18 shows the result of analyzing the solid oxide electrolysis cell according to Example 2 using the SEM before evaluating the degradation rate.

FIG. 19 shows the result of analyzing the solid oxide electrolysis cell according to Example 2 using the SEM after evaluating the degradation rate.

It may be understood that the appended drawings are not necessarily to scale, presenting a somewhat simplified representation of various features illustrative of the basic principles of the present disclosure. The specific design features of the present invention as disclosed herein, including, for example, specific dimensions, orientations, locations, and shapes will be determined in part by the particularly intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the present disclosure(s) will be described in conjunction with exemplary embodiments of the present disclosure, it will be understood that the present description is not intended to limit the present disclosure(s) to those exemplary embodiments. On the contrary, the present disclosure(s) is/are intended to cover not only the exemplary embodiments of the present disclosure, but also various alternatives, modifications, equivalents and other embodiments, which may be included within the spirit and scope of the present disclosure as defined by the appended claims.

The above objects, other objects, features, and advantages of the present disclosure will be easily understood through the following exemplary embodiments However, the present disclosure is not limited to the embodiments described herein and may also be specified in other forms. Rather, the embodiments introduced herein are provided so that the disclosed contents may be thorough and complete and the spirit of the present disclosure may be sufficiently conveyed to those skilled in the art.

Like reference numerals have been used for like components throughout the description of each drawing. In the accompanying drawings, the dimensions of the structures are illustrated enlarged than the actual sizes for clarity of the present disclosure. Terms such as first and second may be used to describe various components, but the components should not be limited by the terms. The terms are used only for the purpose of distinguishing one component from another. For example, a second component may be referred to as a first component, and similarly, the first component may also be referred to as the second component without departing from the scope of the present invention. The singular expression includes the plural expression unless the context clearly dictates otherwise.

In the specification, it should be understood that terms such as “comprise” or “have” are intended to specify that a feature, a number, a step, an operation, a component, a part, or a combination thereof described in the specification is present, but do not preclude the possibility of the presence or addition of one or more other features, numbers, steps, operations, components, parts, or combinations thereof. In addition, when a part such as a layer, a film, a region, or a plate is described as being “on” another part, this includes not only a case in which the part is “directly on” another part, but also a case in which other parts are present therebetween. Conversely, when a part such as a layer, a film, a region, or a plate is described as being “under” another part, this includes not only a case in which the part is “directly under” another part, but also a case in which other parts are present therebetween.

Unless otherwise specified, since all numbers, values, and/or expressions expressing quantities of components, reaction conditions, polymer compositions, and formulations used herein are approximations that reflect various uncertainties of the measurement fundamentally caused when such numbers are obtained among other things, it should be understood that they are described by the term “about” in all cases. In addition, when a numerical range is disclosed herein, the range is contiguous and includes all values from the minimum value to the maximum value in the range, unless otherwise indicated. Furthermore, when the range is an integer, the range includes all integers from the minimum value to the maximum value, unless otherwise indicated.

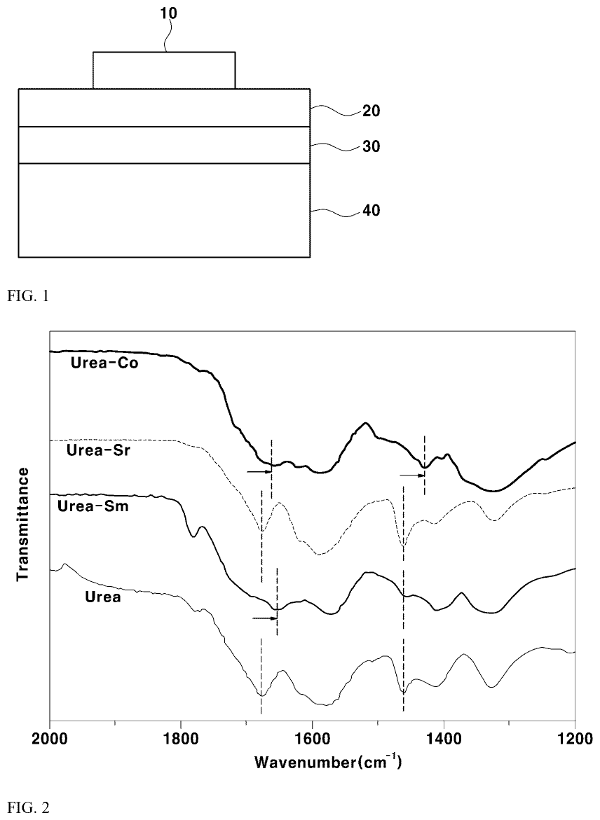

FIG. 1 shows a solid oxide electrolysis cell according to an exemplary embodiment of the present disclosure. The solid oxide electrolysis cell may be a stack of an oxygen electrode 10, an electrolyte 20, a cathode 30, and a cathode support 40.

The oxygen electrode 10 may include a support layer including internal pores and a catalyst supported in the internal pores.

The support layer may have a three-dimensional plate or membrane shape having at least two facing main surfaces. The two main surfaces may each partially have a regular curved surface as well as a mathematical plane, or may have unevenness occurring upon forming the support layer. In this sense, the shape of the support layer is not limited to a relatively thin rectangular parallelepiped.

The thickness of the support layer is not particularly limited. The thickness of the support layer may indicate a gap between two facing main surfaces.

The support layer may include internal pores. The internal pore may be a closed pore or an open pore.

The support layer may include at least one of compounds represented by Chemical Formulas 1, 2, 3, and 4 below:

A1ₙ₊₁B1ₙO₃ₙ₊₁ [Chemical Formula 1]

In Chemical Formula 1, A1 may include La, Nd, Pr, or Ga, and B1 may include Ni, Co, or Cu, and 1≤n≤3 can be satisfied,

A2₁₋ₓ₁A3ₓ₁B2_{1-y1}B3_{y1}O_{3-δ} [Chemical Formula 2]

In Chemical Formula 2, A2 may include La, Ba, or Y, A3 may include Sr or Ca, B2 and B3 may differ from each other and each include Mn, Co, Fe, or Ni, 0<x1<1, 0<y1<1 and 0≤8≤1 can be satisfied,

A4₁₋ₓ₂A5ₓ₂B4_{1-y2}B5_{y2}O_{3-δ}-C_{1-z}D_{z}O_{2-δ} [Chemical Formula 3]

In Chemical Formula 3, A4 may include La, Ba, or Y, A5 may include Sr or Ca, B4 and B5 may differ from each other and each include Mn, Co, Fe, or Ni, C may include Y, Sc, Gd, Sm, or Ca, D may include Zr or Ce, and 0<x2<1, 0<y2<1, 0<z<1, and 0≤δ8≤1 can be satisfied. In Formula 3, “-” may indicate that A4₁₋ₓ₂A5ₓ₂B4_{1-y2}B5_{y}O_{3-δ} has been doped with C_{1-z}D_{z}O_{2-δ}. The doping may indicate a state in which both compounds are physically and chemically bonded, and

A6₁₋ₓ₃3A7ₓ₃B6O_{3-δ} [Chemical Formula 4]

In Chemical Formula 4, A6 may include La, Ba, or Y, A7 may include Sr or Ca, B6 may include Mn, Co, Fe, or Ni, and 0<x3<1 and 0≤δ≤1 can be satisfied.

The support layer may include, for example, Laₙ₊₁NiₙO3ₙ₊₁ (n=1, 2 or 3), La_{0.6} Sr_{0.4}Co_{0.2}Fe_{0.8}O_{3-δ} (0≤δ≤1), La_{0.6}Sr_{0.4}CoO_{3-δ} (0≤δ≤1), etc.

The catalyst may be supported by uniformly infiltrating the internal pores of the support layer.

The catalyst may be free of impurities generated during the manufacturing process and may have a perovskite single-phase structure.

The catalyst may include a compound represented by Chemical Formula 5 below:

A8ₓ₄A9₁₋ₓ₄B7O_{3-δ} [Chemical Formula 5]

In Chemical Formula 5, A8 and A9 may differ from each other and each include Sm, Sr, La, Ca, or Ba, B7 may include Co, Mn, or Fe, and 0<x4<1 and 058≤1 can be satisfied.

The catalyst may include, for example, Sm_{0.5}Sr_{0.5}CoO₃.

An average diameter of the catalyst may be in the range of 20 nm to 30 nm. The average diameter may be calculated by randomly extracting 200 particles from an electron microscope photograph, measuring diameters thereof, and averaging the measured diameters.

The method of manufacturing the oxygen electrode for a solid oxide electrolysis cell according to an exemplary embodiment of the present disclosure may include providing a reactant containing cations resulting from a catalyst precursor by dissolving the catalyst precursor, urea, and glycine in a solvent, obtaining an intermediate by injecting the reactant into a support layer containing internal pores, and thermally treating the intermediate to support the catalyst in the internal pores of the support layer.

The catalyst precursor may include at least one selected from the group consisting of nitrate of the cation, acetate of the cation, and combinations thereof.

The cation may be a cation of an element including at least one selected from the group consisting of Sm, Sr, La, Ca, Ba, Co, Mn, Fe, and combinations thereof.

The catalyst precursor may include samarium nitrate, samarium nitrate hexahydrate, strontium nitrate, cobalt nitrate, or cobalt nitrate hexahydrate. In addition, the cation may include samarium cation, strontium cation, and cobalt cation.

The urea may serve as a complexing agent upon manufacturing reactants. As will be described below, when the intermediate is heated at a low temperature, urea is decomposed and metal hydroxide and/or metal carbonate are precipitated, and thus the catalyst may be uniformly supported in the internal pores of the support layer.

Meanwhile, the urea cannot properly perform the role as a complexing agent for strontium. Therefore, the present disclosure is characterized by forming a catalyst having a single-phase perovskite structure by adding glycine together with the urea to prevent the generation of impurities such as SrCO₃.

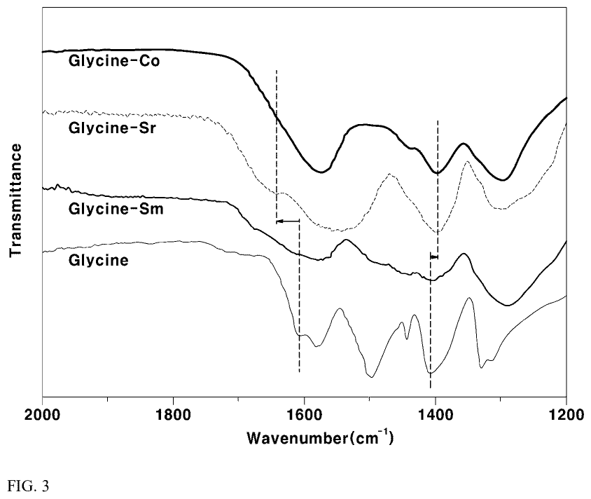

FIG. 2 shows the result of Fourier-transform infrared spectroscopy (FT-IR) analysis when urea and metal cation are bonded. FIG. 3 shows the result of the FT-IR analysis when glycine and metal cations are bonded. Referring to FIG. 2, there is no band shift of urea and strontium. This means that the bond between urea and strontium is weak and thus strontium is easily separated. Therefore, it can be seen that when urea is used alone, the separated strontium may form impurities such as SrCO₃. Referring to FIG. 3, the band shift of glycine and strontium can be clearly seen, which means that glycine is strongly bonded to strontium. Therefore, it is possible to suppress the separation of metal cations by using glycine and urea together.

The reactant may include urea and cations at a molar ratio of 5:1 to 15:1. The reactant may include glycine and cations at a molar ratio of 0.5:1 to 5:1. When the molar ratio of urea and glycine is within the above range, the catalyst may be formed without impurities by being strongly bonded with the cation resulting from the catalyst precursor.

The solvent is water, or a mixed solvent of water and alcohol. The mixed solvent may include the alcohol and water at a volume ratio of 0.1:1 to 2:1.

The method of providing the reactant is not particularly limited. For example, the reactant may be provided by first dissolving the catalyst precursor, urea, and glycine in water and then adding and mixing alcohol with low surface energy at the above volume ratio.

The support layer may be thermally treated at 300° C. to 400° C. The support layer may be thermally treated to remove impurities present in the internal pores. Therefore, the reactant may be more smoothly injected into the support layer.

The method of injecting the reactant into the support layer is not particularly limited. An intermediate may be obtained by impregnating the support layer with a reactant, dropping the reactant into the support layer, or applying the reactant to the support layer.

The amount of the reactant injected is not particularly limited. An appropriate amount of the reactant may be injected in consideration of the porosity, specific surface area, and amount of the desired catalyst supported of the support layer.

The manufacturing method may further include decomposing the urea by heating the intermediate to 70° C. to 100° C. before thermally treating the intermediate. When the temperature in the decomposing of urea exceeds 100° C., a drying effect occurs and the reactants move to the surface of the support layer due to a capillary force, and thus the catalyst cannot be properly supported in the internal pores of the support layer.

The supporting of the catalyst may include thermally treating the intermediate at 60° C. to 700° C. When the intermediate is thermally treated, the catalyst precipitated or attached to the internal pores of the support layer may be crystallized to allow the catalyst and the support layer to be more strongly bonded.

Hereinafter, the present disclosure will be described in more detail through specific examples, etc. according to an exemplary embodiment of the present disclosure.

However, the scope and content of the present disclosure cannot be construed as being reduced or limited by these examples, etc., and based on the present disclosure of the present disclosure including the following examples, it is apparent that the present disclosure for which no specific experimental results are presented can be carried out by those skilled in the art.

### Manufacturing Example

As catalyst precursors, samarium nitrate hydrate (Sm(NO₃)₃·6H₂O), strontium nitrate (Sr(NO₃)₂), and cobalt nitrate hydrate (Co(NO₃)₂·6H₂O) were provided by being weighed according to the composition of Sm_{0.5}Sr_{0.5}CoO₃.

After dissolving the catalyst precursor in water, urea and glycine were added to the resultant. The molar ratio of the urea and the cation resulting from the catalyst precursor was 10:1. The molar ratio of the glycine and the cation resulting from the catalyst precursor was 1:1. Thereafter, the reactant was provided by adding and mixing ethanol. The volume ratio of water and ethanol was adjusted to 55:45.

The reactant was heated at about 80° C. for about 1 hour, and the resultant was thermally treated at about 650° C. for about 2 hours to obtain a catalyst in powder form.

### Comparative Manufacturing Example 1

A catalyst in powder form was manufactured in the same manner as in the above manufacturing example, except that glycine was not added.

### Comparative Manufacturing Example 2

A catalyst in powder form was manufactured in the same manner as in the above manufacturing example, except that the molar ratio of urea and cation resulting from the catalyst precursor was adjusted to 1:1.

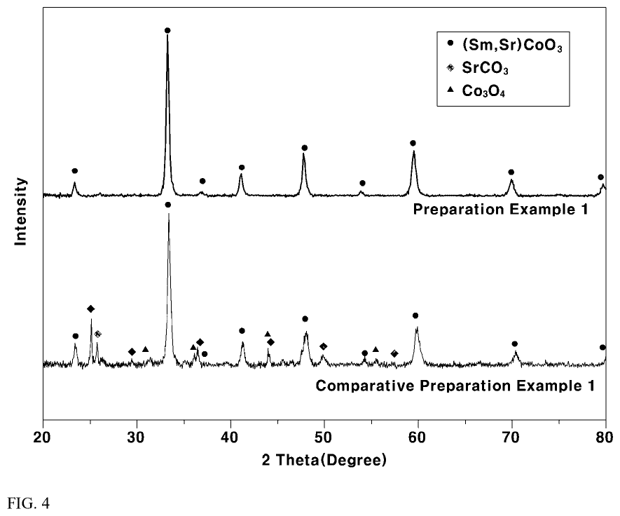

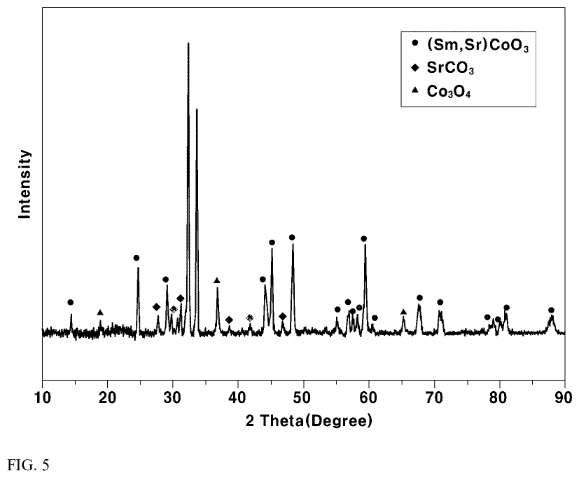

FIG. 4 shows the result of X-ray diffraction (XRD) analysis of the catalyst according to Manufacturing Example and Comparative Manufacturing Example 1. FIG. 5 shows the result of the X-ray diffraction analysis of the catalyst according to Comparative Manufacturing Example 2. Referring to FIG. 4 and FIG. 5, while the catalyst according to Manufacturing Example shows a single-phase perovskite structure, the peaks due to impurities such as SrCO₃ and Co₃O₄ are found in Comparative Manufacturing Example 1 and Comparative Manufacturing Example 2.

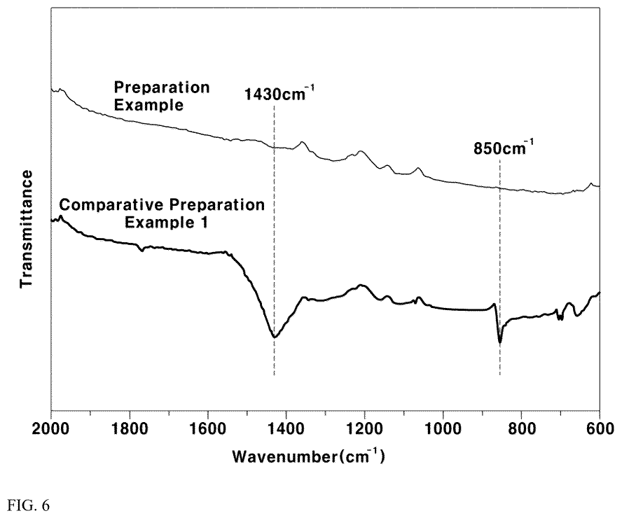

FIG. 6 shows the result of the FT-IR analysis of the catalyst according to Manufacturing Example and Comparative Manufacturing Example 1. In Comparative Manufacturing Example 1, strong peaks related to the SrCO₃ phase were found at 1430 cm⁻¹ and 850 cm⁻¹, but the corresponding peaks were not shown in the result of Manufacturing Example.

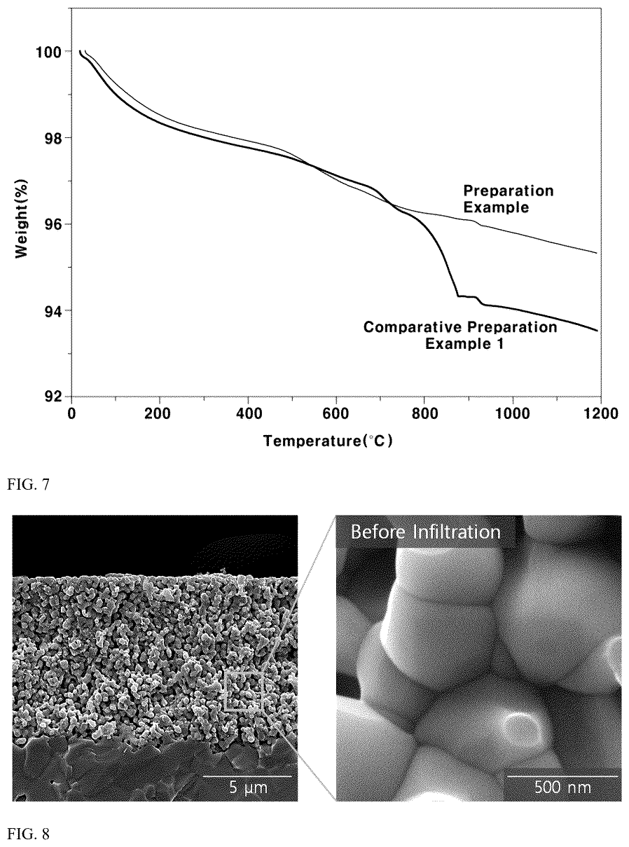

FIG. 7 shows the result of thermogravimetric analysis (TGA) of the catalyst according to Manufacturing Example and Comparative Manufacturing Example 1. While Manufacturing Example shows a gradual weight loss up to 1,200° C., Comparative Manufacturing Example 1 shows a rapid weight loss due to thermal decomposition of the SrCO₃ phase at 800° C. to 1,000° C.

Therefore, it can be seen that a single-phase catalyst may be manufactured without impurities by using urea and glycine together at an appropriate ratio as in the present disclosure.

### Example 1

As catalyst precursors, samarium nitrate hydrate (Sm(NO₃)₃·6H₂O), strontium nitrate (Sr(NO₃)₂), and cobalt nitrate hydrate (Co(NO₃)₂·6H₂O) were provided by being weighed according to the composition of Sm_{0.5}Sr_{0.5}CoO₃.

After dissolving the catalyst precursor in water, urea and glycine were added to the resultant. The molar ratio of the urea and the cation resulting from the catalyst precursor was 10:1. The molar ratio of the glycine and the cation resulting from the catalyst precursor was 1:1. Thereafter, the reactant was provided by adding and mixing ethanol. The volume ratio of water and ethanol was adjusted to 55:45.

A plate-shaped electrolyte containing gadolinium doped ceria (GDC) and having the thickness of about 2 mm was provided. A support layer was formed on both surfaces of the electrolyte. The support layer includes a functional layer including LSCF-GDC and attached to the electrolyte, and a current collection layer located on the functional layer and including LSCF.

An intermediate was obtained by injecting the reactant into the support layer and then heating the support layer at about 80° C. for about 1 hour. A solid oxide electrolysis cell having a symmetrical cell structure in which an oxygen electrode was formed on both surfaces of the electrolyte was obtained by thermally treating the intermediate at about 650° C. for about 2 hours.

### Comparative Example 1

A solid oxide electrolysis cell was manufactured in the same manner as Example 1, except that glycine was not used.

### Comparative Example 2

A solid oxide electrolysis cell having a stacking structure of support layer-electrolyte-support layer in which no reactant was injected in Example 1 was set to Comparative Example 2.

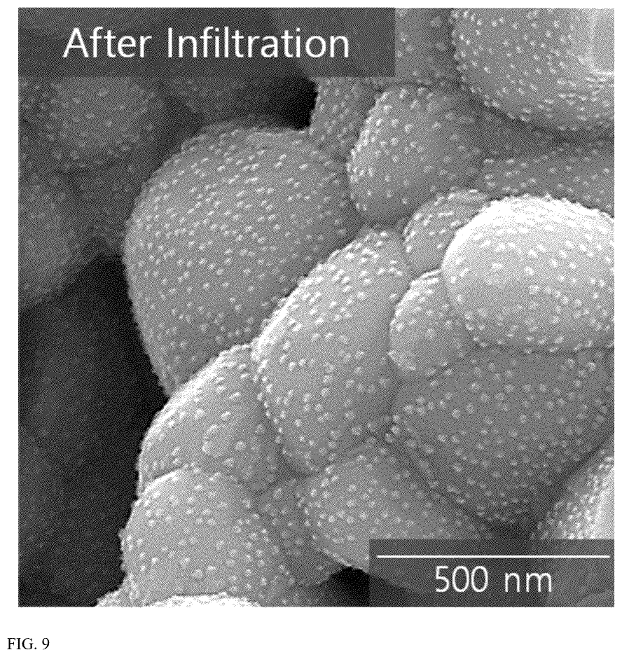

FIG. 8 shows the result of scanning electron microscope (SEM) analysis of an oxygen electrode for a solid oxide electrolysis cell according to Comparative Example 2. FIG. 9 shows the result of the SEM analysis of the oxygen electrode for a solid oxide electrolysis cell according to Example 1. Referring to FIG. 9, it can be seen that the catalyst having an average diameter of about 20 nm to 30 nm is very evenly supported in the internal pores of the support layer.

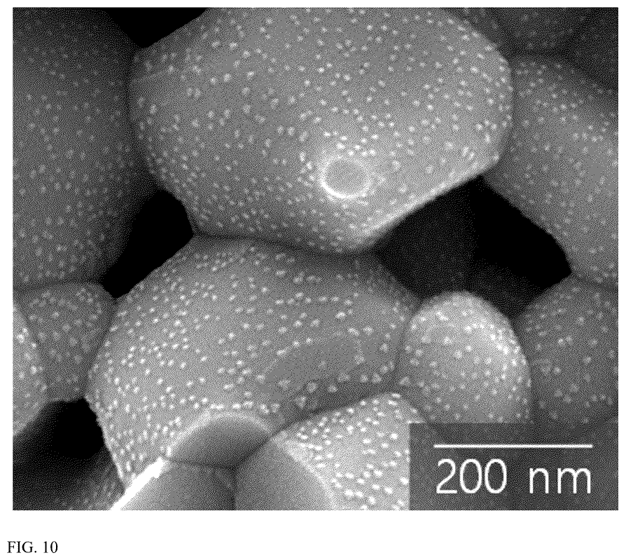

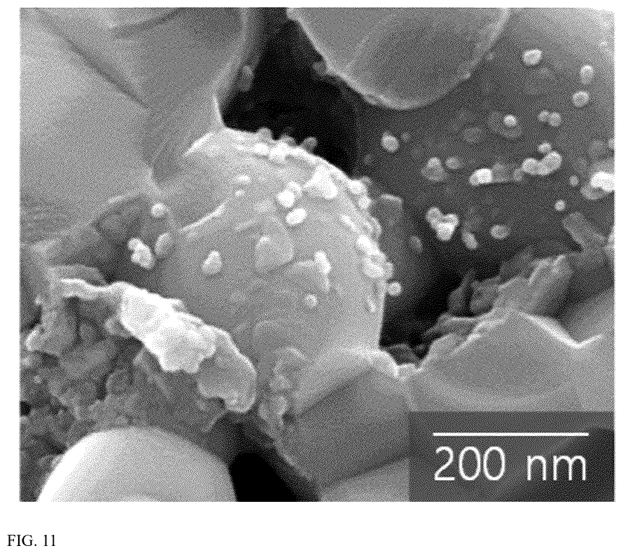

FIG. 10 shows the result of sintering the oxygen electrode for a solid oxide electrolysis cell according to Example 1 at about 650° C. for about 100 hours and then analyzing the resultant using the SEM. FIG. 11 shows the result of sintering the oxygen electrode for a solid oxide electrolysis cell according to Comparative Example 1 at about 650° C. for about 100 hours and then analyzing the resultant using the SEM. Referring to FIG. 11, the size of the oxygen electrode manufactured without using glycine grows to about 100 nm due to the aggregation of the catalyst. On the other hand, referring to FIG. 10, it can be seen that the form of the catalyst in the oxygen electrode according to Example 1 was not modified.

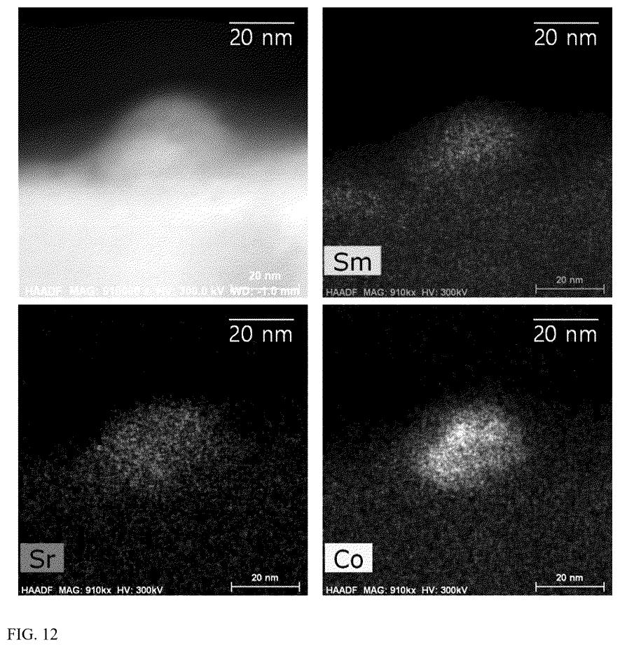

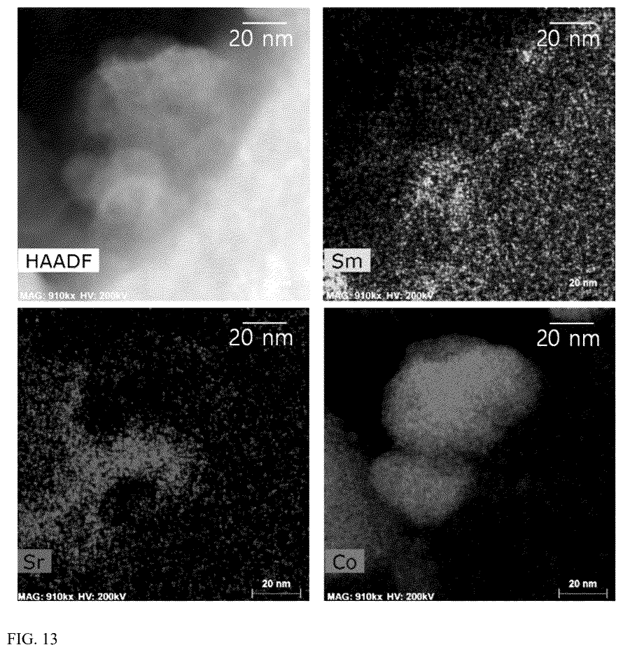

FIG. 12 shows the result of observing the oxygen electrode for a solid oxide electrolysis cell according to Example 1 using the SEM. FIG. 13 shows the result of observing the oxygen electrode for a solid oxide electrolysis cell according to Comparative Example 1 using the SEM. Referring to FIG. 12, and FIG. 13, it can be seen that while samarium, strontium, and cobalt are present uniformly in Example 1, the elements are separated and take different forms in Comparative Example 1.

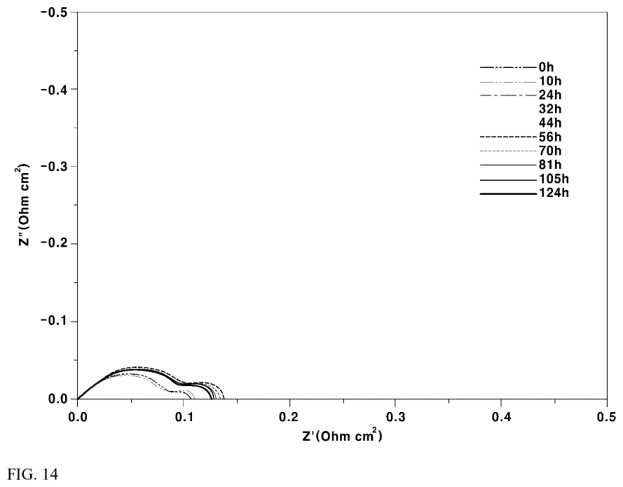

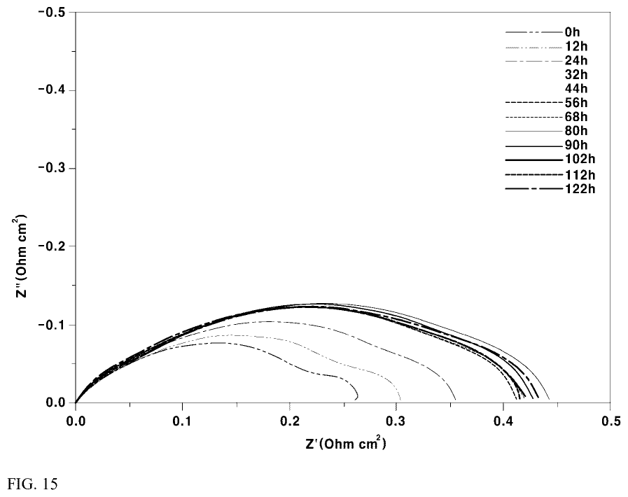

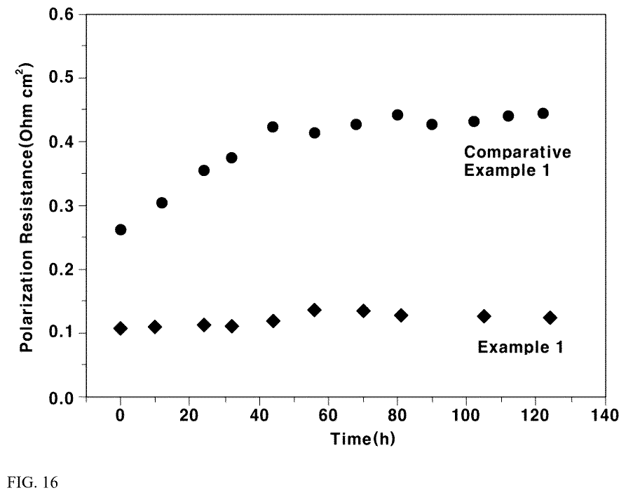

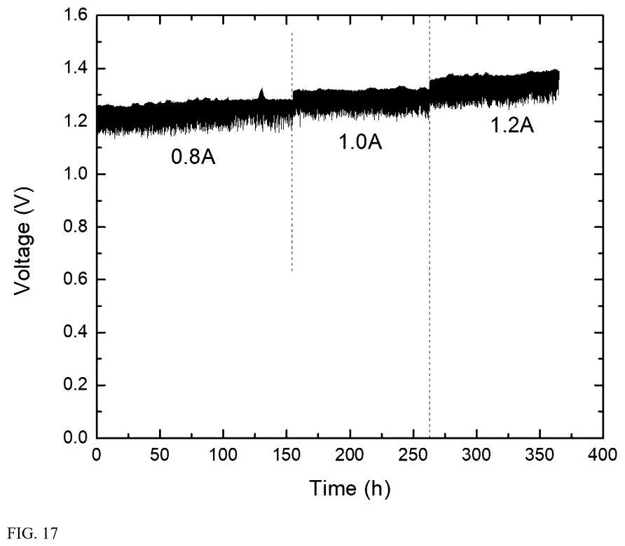

FIG. 14 shows the result of measuring electrochemical performance of the solid oxide electrolysis cell according to Example 1. FIG. 15 shows the result of measuring electrochemical performance of the solid oxide electrolysis cell according to Comparative Example 1. The electrochemical performance of each cell was measured by using Solartron 1260/1287. FIG. 16 shows the result of measuring the polarization resistance of the solid oxide electrolysis cell according to Example 1 and Comparative Example 1. Referring to FIG. 16, it can be seen that the resistance of Example 1 was greatly reduced compared to Comparative Example 1.

### Example 2

A solid oxide electrolysis cell was manufactured in the same manner as Example 1, except that LSC was used as the oxygen electrode.

FIG. 17 shows the result of measuring a degradation rate of the solid oxide electrolysis cell according to Example 2. The cell was evaluated for 155 hours at 0.8 A/cm², 108 hours at 1.0 A/cm², and 100 hours at 1.2 A/cm². The evaluation environment was about 700° C., and the volume ratio of hydrogen and water vapor was 1:1. Referring to FIG. 17, the cell operates very stably. Specifically, it can be seen that the cell has almost no performance degradation because a degradation rate calculated from a difference between initial and final voltages in a section in which a current density is 0.8 A/cm² is about 8.7% and a degradation rate calculated from the difference between the initial and final voltages in a section in which the current density is 1.0 A/cm² is about 9.2%.

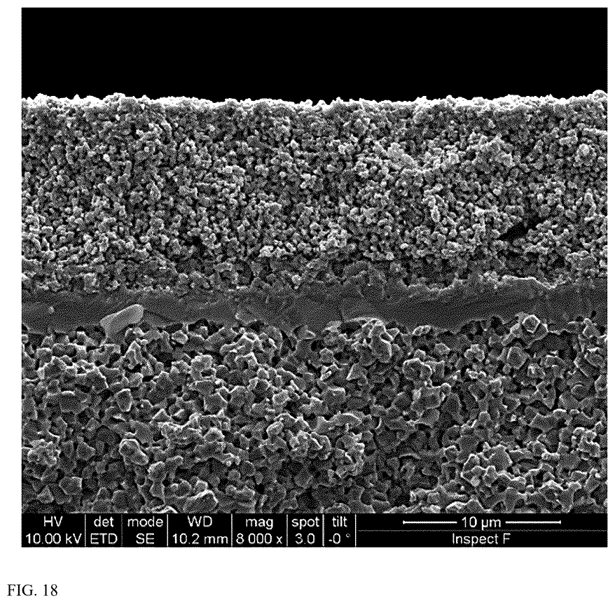

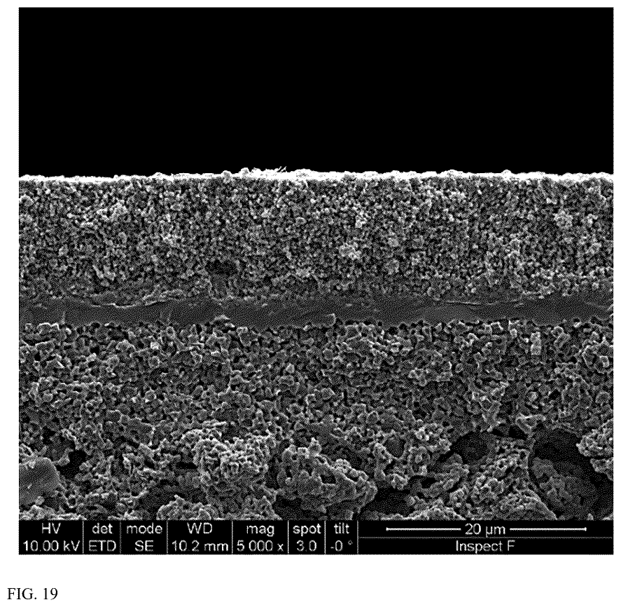

FIG. 18 shows the result of analyzing the solid oxide electrolysis cell according to Example 2 using the SEM before evaluating the degradation rate. FIG. 19 shows the result of analyzing the solid oxide electrolysis cell according to Example 2 using the SEM after evaluating the degradation rate. Referring to FIG. 19, it can be seen that in Example 2, the oxygen electrode was not peeled even after operating for about 360 hours.

The foregoing descriptions of specific exemplary embodiments of the present invention have been presented for purposes of illustration and description. They are not intended to be exhaustive or to limit the present disclosure to the precise forms disclosed, and obviously many modifications and variations are possible in light of the above teachings. The exemplary embodiments were chosen and described in order to explain certain principles of the present disclosure and their practical application, to enable others skilled in the art to make and utilize various exemplary embodiments of the present invention, as well as various alternatives and modifications thereof. It is intended that the scope of the present disclosure be defined by the Claims appended hereto and their equivalents.

What is claimed is:

1. An oxygen electrode for a solid oxide electrolysis cell, the oxygen electrode comprising:
a support layer comprising internal pores; and
a catalyst supported in the internal pores,
wherein the catalyst comprises a perovskite single phase structure.

2. The oxygen electrode of claim 1, wherein the support layer comprises at least one of compounds represented by Chemical Formulas 1, 2, 3, and 4 below:
A1ₙ₊₁B1ₙO₃ₙ₊₁ [Chemical Formula 1]
in Chemical Formula 1, A1 comprises La, Nd, Pr, or Ga, and B1 comprises Ni, Co, or Cu, and 1≤n≤3 is satisfied,
A2₁₋ₓ₁A3ₓ₁B2_{1-y1}B3_{y1}O_{3-δ} [Chemical Formula 2]
in Chemical Formula 2, A2 comprises La, Ba, or Y, A3 comprises Sr or Ca, B2 and B3 differ from each other and each comprise Mn, Co, Fe, or Ni, 0<x1<1, 0<y1<1 and 0≤δ≤1 are satisfied,
A4₁₋ₓ₂A5ₓ₂B4_{1-y2}B5_{y2}O_{3-δ}-C_{1-z}D_{z}O_{2-δ} [Chemical Formula 3]
in Chemical Formula 3, A4 comprises La, Ba, or Y, A5 comprises Sr or Ca, B4 and B5 differ from each other and each comprise Mn, Co, Fe, or Ni, C comprises Y, Sc, Gd, Sm, or Ca, D comprises Zr or Ce, and 0<x2<1, 0<y2<1, 0<z<1, and 0≤δ≤1 are satisfied, and
A6₁₋ₓ₃3A7ₓ₃B6O_{3-δ} [Chemical Formula 4]
in Chemical Formula 4, A6 comprises La, Ba, or Y, A7 comprises Sr or Ca, B6 comprises Mn, Co, Fe, or Ni, and 0<x3<1 and 058≤1 are satisfied.

3. The oxygen electrode of claim 1, wherein the catalyst comprises a compound represented by Chemical Formula 5 below:
A8ₓ₄A9₁₋ₓ₄B7O_{3-δ} [Chemical Formula 5]
in Chemical Formula 5, A8 and A9 differ from each other and each comprise Sm, Sr, La, Ca, or Ba, B7 comprises Co, Mn, or Fe, and 0<x4<1 and 0≤δ≤1 are satisfied.

4. The oxygen electrode of claim 1, wherein the catalyst has an average diameter of 20 nm to 30 nm.

5. A method of manufacturing an oxygen electrode for a solid oxide electrolysis cell, the method comprising:
providing a reactant including cations resulting from a catalyst precursor by dissolving the catalyst precursor, urea, and glycine in a solvent;
obtaining an intermediate by injecting the reactant into a support layer including internal pores; and
thermally treating the intermediate to support the catalyst in the internal pores of the support layer,
wherein the catalyst comprises a perovskite single phase structure.

6. The method of claim 5, wherein the catalyst precursor comprises at least one selected from the group consisting of nitrate of the cation, acetate of the cation, and combinations thereof.

7. The method of claim 5, wherein the solvent comprises alcohol and water at a volume ratio of 0.1:1 to 2:1.

8. The method of claim 5, wherein the cation is a cation of an element comprising at least one selected from the group consisting of Sm, Sr, La, Ca, Ba, Co, Mn, Fe, and combinations thereof.

9. The method of claim 5, wherein the reactant comprises the urea and cations at a molar ratio of 5:1 to 15:1.

10. The method of claim 5, wherein the reactant comprises the glycine and cations at a molar ratio of 0.5:1 to 5:1.

11. The method of claim 5, wherein the support layer comprises at least one of compounds represented by Chemical Formulas 1, 2, 3, and 4 below:
A1ₙ₊₁B1ₙO₃ₙ₊₁ [Chemical Formula 1]
in Chemical Formula 1, A1 comprises La, Nd, Pr, or Ga, and B1 comprises Ni, Co, or Cu, and 1≤n≤3 is satisfied,
A2₁₋ₓ₁A3ₓ₁B2_{1-y1}B3_{y1}O_{3-δ} [Chemical Formula 2]
in Chemical Formula 2, A2 comprises La, Ba, or Y, A3 comprises Sr or Ca, B2 and B3 differ from each other and each comprise Mn, Co, Fe, or Ni, 0<x1<1, 0<y1<1 and 0≤δ≤1 are satisfied,
A4₁₋ₓ₂A5ₓ₂B4_{1-y2}B5_{y2}O_{3-δ}-C_{1-z}D_{z}O_{2-δ} [Chemical Formula 3]
in Chemical Formula 3, A4 comprises La, Ba, or Y, A5 comprises Sr or Ca, B4 and B5 differ from each other and each comprise Mn, Co, Fe, or Ni, C comprises Y, Sc, Gd, Sm, or Ca, D comprises Zr or Ce, and 0<x2<1, 0<y2<1, 0<z<1, and 0≤δ8≤1 are satisfied, and
A6₁₋ₓ₃3A7ₓ₃B6O_{3-δ} [Chemical Formula 4]
in Chemical Formula 4, A6 comprises La, Ba, or Y, A7 comprises Sr or Ca, B6 comprises Mn, Co, Fe, or Ni, and 0<x3<1 and 0≤δ≤1 are satisfied.

12. The method of claim 5, wherein the support layer is thermally treated at 300° C. to 400° C.

13. The method of claim 5, further comprising decomposing the urea by heating the intermediate to 70° C. to 100° C. before thermally treating the intermediate.

14. The method of claim 5, wherein the supporting of the catalyst comprises thermally treating the intermediate at 60° C. to 700° C.

15. The method of claim 5, wherein the catalyst comprises a compound represented by Chemical Formula 5 below:
A8ₓ₄A9₁₋ₓ₄B7O_{3-δ} [Chemical Formula 5]
in Chemical Formula 5, A8 and A9 differ from each other and each comprise Sm, Sr, La, Ca, or Ba, B7 comprises Co, Mn, or Fe, and 0<x4<1 and 0<δ≤1 are satisfied.

16. The method of claim 5, wherein the catalyst has 20 nm to 30 nm of an average diameter.
